(19) United States
(12) Patent Application Publication
(10) Pub. No.: US 2008/0059224 A1
(43) Pub. Date: Mar. 6, 2008

(54) Systems and methods for developing a comprehensive patient health profile

(76) Inventor: Alan M. Schechter, Long Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/514,585

(22) Filed: Aug. 31, 2006

(51) Int. Cl. G06Q 10/00

(52) U.S. Cl. 705/2

(57) ABSTRACT

A system and method for generating a health profile by processing and mapping health care data for an individual or a group of individuals, to identify categorical associations of health care data and predict occurrences of associated categories of such data. The system comprises a plurality of central networks that communicate with a remote device through a global electronic network. Data is retrieved through the global electronic network and processed by a remote device to create a map of the health status of an individual or a group of individuals. The health profile can be used to manage the treatment and health of an individual or a group of individuals. The health profile may be encoded on an integrated circuit chip or a card having a magnetic strip.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is directed to creating a health profile for an individual patient or a group of patients based on factors such as a diagnosed disease state, point of service and cost. More particularly, the present invention comprises a system and method which are utilized to construct a history of the healthcare data of an individual patient or a group of individual patients. The system and method may be used to identify associated co-morbidities and to predict future co-morbidities. The system and method may further be used to develop a holistic treatment approach for the disease management of an individual.

Disease management programs have always been a traditional and necessary aspect of the healthcare service provided by managed care organizations. Disease management is the strategy of delivering healthcare to individual patients through a system of coordinated intervention and communication. In theory, a disease management program is intended to be a patient-centered approach to provide healthcare services and should be designed to address multiple aspects of the general health state of the individual patient utilizing nationally recognized standards of care. Ultimately, a properly structured disease management program should lower the associated cost of healthcare by reducing the use of unnecessary or duplicative services and avoiding particular treatments that are generally associated with poor outcomes.

Disease management programs should be developed to manage the health of the individual patient in a manner that directly correlates to the best treatment method for that individual. A healthcare provider initially evaluates the exhibited symptoms of the individual patient and determines a proper diagnosis based on the symptoms. Subsequent to the diagnosis, a relevant course of treatment is developed that is tailored to the needs of the individual patient. The prescribed course of treatment should involve a multitude of strategies to effectively manage the health of the individual patient, such as application of clinical guidelines, techniques for self-care founded on patient education and provider training and continuous analysis of the patient's most current clinical data.

The disease management program should also encourage communication between the practitioner and patient because communication is beneficial to the practitioner/patient relationship. In particular, communication facilitates the feedback necessary for behavior modification which may prevent, or at least delay, disease progression. For example, a provider can effectively intervene in the healthcare of an individual patient and improve the health outcome of the patient if a properly structured disease management program is in place. Moreover, prevention of disease complications is a proven result of behavior modification and surveillance of compliance with healthcare directives.

Despite their utility, disease management programs are inherently deficient for several reasons. First, the programs are designed to focus only on the specific disease state that is currently diagnosed by the provider. Although the healthcare provider may recognize that other concomitant conditions, or co-morbidities, may be simultaneously developing, patient treatment is usually limited to the current diagnosed disease state of the individual patient with minor treatment for other conditions of which a patient is exhibiting symptoms. Associated concomitant conditions or co-morbidities that are not directly related to the currently diagnosed disease state are often not treated or managed at the same time. As a result, the individual patient may require multiple visits to multiple healthcare providers including specialists, in-patient and outpatient facilities and emergency care facilities, which places an increased pressure on already limited healthcare resources. These additional visits can complicate the overall treatment of the individual patient because the primary healthcare provider is generally not aware of the visits unless the individual patient communicates the same to the provider. Moreover, the individual patient often provides inaccurate or incomplete data to the provider, so the provider may not have a complete history of the general state of health of the individual patient unless the provider requests copies of the relevant records from other providers.

Another common deficiency of disease management programs involves the ability to predict the manifestation of an individual patient's diagnosed disease state in other family members of the individual. Many of the common diseases of adult life, such as diabetes mellitus, hypertension and schizophrenia have a strong genetic component to their occurrence. Generally, family members that may be genetically predisposed to an already-identified and diagnosed disease condition are not pre-screened or monitored prior to the development or onset of symptoms of the possibly inherited disease state. Likewise, family members are not provided with any advice or counsel regarding lifestyle or other behavioral changes that can be made to attempt to avoid the onset of disease. As a result, a potentially affected family member does not begin any treatment, preventative or otherwise, until that family member develops symptoms of the disease state. A properly structured disease management program should address the diagnosis at its genetic source and through the bloodline to prevent disease proliferation or at least lessen the often devastating health effects in the family members. Moreover, once a healthcare provider becomes aware that an individual patient has family members who may be at risk, the healthcare provider should not only focus on the genetically inherited diagnosed disease state for the affected family members, but also the concomitant co-morbidities that may be anticipated or unexpected.

Heritage Provider Network, Inc., a managed service organization of Heritage Development Organization, Inc., performed a study on the members of its covered population to determine the additional healthcare costs associated with treating a current diagnosed disease state and other co-morbidities versus treating only the known current diagnosed disease state. The dataset of the population considered in the study conducted by Heritage Provider Network, Inc. was constructed from approximately two million claim records of individual covered members that had sought treatment over a two year period for at least one disease state. Eighteen pre-determined disease states were selected for further analysis with regard to the likelihood of an occurrence of an additional disease state. The study required the accurate identification of all past and present disease states as diagnosed in the individual member to predict additional co-morbidities, if any, likely to be suffered by the member. Other factors included the point of service and associated costs. A health profile was created that included a detailed historical analysis of the treatment for each individual. The study revealed that the cost of managing the current diagnosed disease state in addition to other later developed co-morbidities and concomitant conditions was over ten times the cost of managing only the current diagnosed disease state. The results of the study were also found to be predictive regarding both anticipated and unexpected future co-morbidities associated with each known diagnosed disease state.

Prior art disease management programs are, in large part, based on general healthcare data. Such data is available in large abundance in raw form. However, raw data is not useful unless it is converted into usable format that facilitates improved clinical, financial and operational decisions. For example, disease registries and other health profiling-applications are components of a field related to clinical decision support systems, or CDSS. Such systems form a significant part of the field of clinical knowledge management technologies. CDSS aids the clinical process through the use of artificial intelligence and knowledge obtained from diagnosis and investigation. These processes may be incorporated into treatment and long term care programs. CDSS are mainly considered active knowledge systems that integrate specific patient data into a medical knowledge database and an inference system to generate case specific advice. These interactive computer programs directly assist providers with decision-making tasks with regard to the patient.

One such CDSS, disclosed by Ciarniello, et al., U.S. Pat. No. 6,802,810, issued Oct. 12, 2004, teaches a Care Engine, which is an early warning trigger analysis system that enables early detection of patient health risks. Ciarnello identifies that incomplete individual patient clinical data can lead to inefficiencies and lapses in individual patient care. Ciarnello recognizes that individual patient care is often sought and delivered in unrelated locations and, as a result, critical patient data is stored in many different locations. Ciarnello further identifies all participants in the healthcare system as suppliers of data that rely on the data provided by each other to perform their roles.

Ciarnello attempts to provide a solution that is intended to improve the quality of care and better manage healthcare costs by aggregating data provided to healthcare organizations and physicians for an accurate diagnosis and treatment. Ciarnello aggregates both artificial intelligence and specific patient data from a multiplicity of databases including laboratory test results, prescription drug data, health plan claims data and patient notes. Ciarnello's Care Engine analyzes the data to find at-risk individuals for case management before these individuals experience high-cost medical events. The Care Engine further stratifies high risk populations according to clinical criteria which can include severity of the disease state and associated co-morbidities. The care received by an individual can be compared to established standards of clinical excellence to determine if a patient is being medically mismanaged.

Ciarnello attempts to present a comprehensive solution to care management by aggregating and integrating clinical data from disparate sources to provide treatment options that are specific to an individual patient and more general with regard to the population at-large. Developing a well-defined disease management program for a specific individual patient or any group of similarly suffering individual patients involves the analysis of several other factors not considered by Ciarnello. First, Ciarnello fails to address how the current diagnosed disease state affects the future healthcare of the individual patient. Ciarnello focuses only on artificial intelligence and clinical data as it relates to identifying a current disease state to further provide treatment suggestions and manage the patient's present health status. Ciarnello does not consider past medical data, such as hospitalizations or prior unrelated diagnoses, or future health status, such as anticipated or unexpected co-morbidities. Next, Ciarnello fails to address the cost associated with the management of the individual patient's health. Both potential and actual cost of healthcare services, as realized by the treating healthcare provider, the medical group or the health plan of the individual patient, can affect the methods of treatment recommended and utilized to treat a diagnosed disease state of a patient. More expensive diagnostic treatment procedures or preventative strategies may be denied in favor of less expensive maintenance measures. Finally, Ciarnello further fails to address additional factors such as place of service and frequency of multiple provider utilization, which also affect the cost of healthcare and the overall patient treatment. Depending on the type of provider with whom a patient seeks treatment, the cost of services may vary drastically. Emergency room care typically costs more than a health care professional regular visit. However, if a patient's health care status is not adequately addressed in a regular visit, emergency room treatment may be inevitable.

As a result of the aforementioned deficiencies in both disease management programs and the prior art and the inefficiencies in the delivery of treatment to afflicted individual patients, there is a substantial need in the art for a system and method for creating a patient health profile that provides useful data to all participants in the healthcare system. The health profile should present a history of the health of the individual patient that accounts for past and present disease states and both anticipated and unexpected co-morbidities. The profile should further provide an analysis of other healthcare data relative to the health of the individual patient, including but not limited to, treatment, point of service, and cost. The system and method should not use artificial intelligence, like Ciarnello, as the sole method to diagnose a disease state and to develop an appropriate course of treatment. Instead, the health profile should incorporate actual data, such as disease state occurrences, to guide each health care provider in effectively managing the treatment and health of an individual patient.

The system and method should enable physicians and other healthcare providers to develop a customized and holistic approach to individual patient disease management that focuses on multiple co-morbidities, whether currently suffered or not yet diagnosed. In addition, the system should enable an individual patient's physician to identify family members of the particular patient who may have an affected health status so that preventative strategies may be instituted.

### BRIEF SUMMARY

A system and method of developing a health profile are disclosed that take a broader holistic and proactive approach to identify and manage members with diagnosed disease states. The disclosed system and method improves data content provided to the individual patient's healthcare provider by identifying all diagnosed conditions and co-morbidities, point of service utilization and cost. The health profile provides the healthcare professional with a map of past and present, possibly associated, diagnosed disease states either for an individual patient or a group of individual patients. The health profile can be utilized by the healthcare professional to predict additional co-morbidities that may be developing now or may develop in the future to avoid the costly associated provider utilization. The healthcare provider can use the health profile to identify and anticipate co-morbidities and manage the same simultaneously with the current diagnosed disease state. Early intervention in the form of behavioral modification may also be instituted to reduce the cost of future healthcare services incurred as a result of the added undiagnosed complications and the need for additional services resulting from these conditions.

A method of constructing a health profile for an individual patient or a group of individual patients is disclosed that enables a healthcare provider to identify disease states that have a genetic predisposition. By identifying such genetic diseases in patients, family members of patients with these conditions can be pre-screened and monitored prior to developing symptoms of these disease states. The current health status of the particular family members can be adequately assessed based on the known condition of the individual patient to anticipate the future healthcare needs of the potentially affected family member.

The disclosed health profile system may also be used to facilitate the development of population healthcare management programs by tracking healthcare utilization statistics and predict future co-morbidities based thereon. The health profile and the interpretations that can be derived therefrom may be of interest to anyone having a role in the management of healthcare treatment and associated cost. For example, the health profile can be utilized by the patient to manage his or her own care; the primary care physician or other healthcare provider such as a specialist or a medical group can utilize the health profile to predict future disease states in a group of individual patients and streamline preventative strategies and care; the patient's insurance company, employer groups and other organizations, agencies or other governmental groups on a county, state or federal level can utilize the health profile to determine the cost effectiveness of the standard treatment methods for a particular disease state.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flowchart depicting the steps for practicing the present invention as it relates to creating a health profile in accordance with the method of the present invention.

FIG. 2 is a block diagram of an exemplary system that may be used to create a health profile in accordance with the method of the present invention.

FIG. 3 is a list of disease registry categories and associated ICD-9 codes.

FIG. 4 is a representation of a health profile created in accordance with the system and method of the present invention.

FIG. 5 is another representation of a health profile.

FIGS. 6 and 7 represent a first and second output for a statistical analysis of the likelihood of disease occurrence according to an aspect of the present invention.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are intended to be encompassed within the scope of the invention.

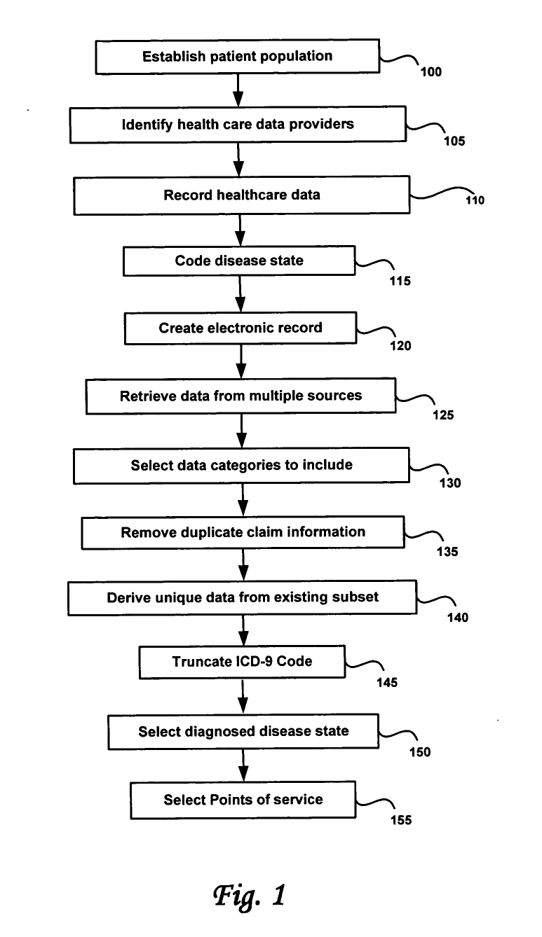

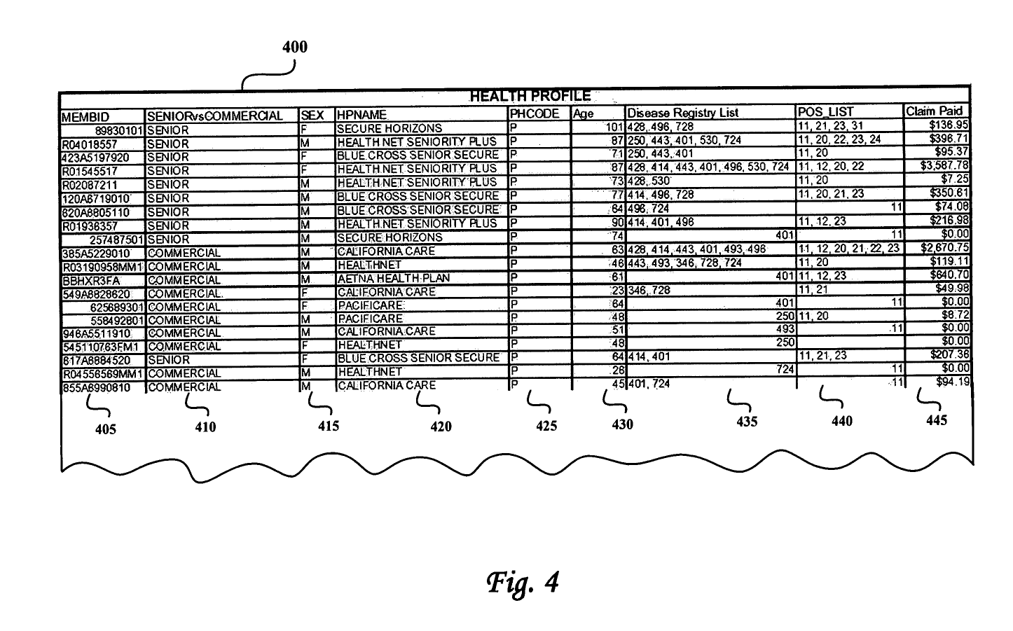

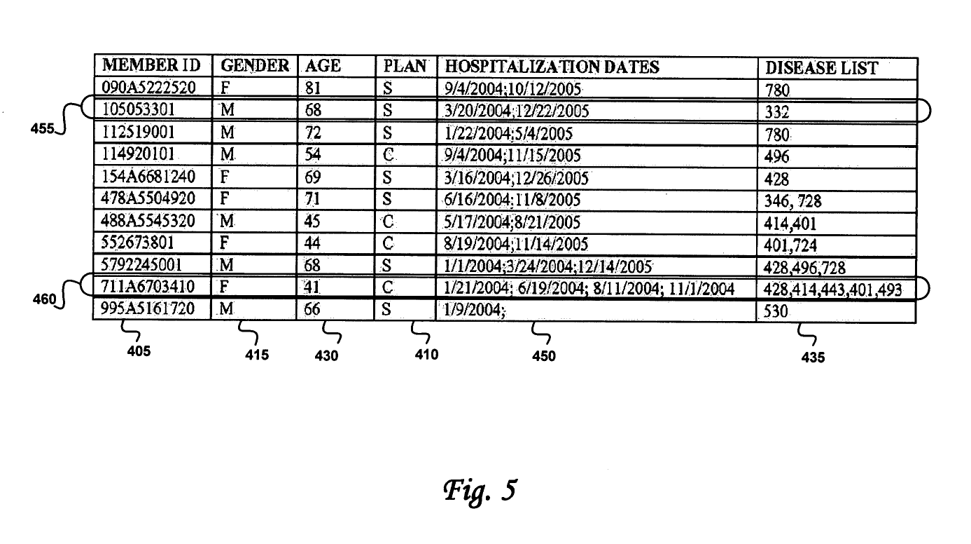

Referring now to FIG. 1, there is articulated the various steps by which the present invention operates to construct a health profile, which is shown in FIGS. 4 and 5. The health profile can be constructed using any data mining software program having an analytical suite of operational components. An example of a suitable data mining software program is PolyAnalyst 6 sold by Megaputer Intelligence, Inc. of Bloomington, Ind. The steps further illustrate how such a health profile can be utilized to provide updated and relevant healthcare data to an individual patient's healthcare providers so that the providers may timely identify and adequately treat both anticipated and unexpected co-morbidities.

To create a health profile, a patient population to which healthcare is provided must first be established at step 100. The patient population established at step 100 may consist of the individual covered members of a managed care organization or any subset thereof. The established patient population may also consist of any group of individuals for which a set of conditions can be identified and analyzed to further create a map of healthcare treatment as it relates to the established patient population, as described herein.

A plurality of disparate healthcare data providers is identified at step 105. This plurality of healthcare data providers comprises healthcare professionals, healthcare institutions and any other organization or group that is not a healthcare professional or healthcare institution but is capable of storing healthcare data or other data regarding treatments or interactions with an individual patient or data that may be relevant to the health of the general patient population. The group may generally include, but is not limited to physicians, specialists, emergency facilities, inpatient and outpatient facilities, medical groups, insurance companies, employers, county, state and federal level agencies or groups and veteran's care facilities. The healthcare professionals and institutions may include any professional or facility that is capable of delivering medical treatment or services to individual patients within the established patient population. The healthcare professionals and institutions are usually responsible for assessment, diagnosis and treatment of individual patients within the patient population seeking such treatment. Health care providers may further include individuals or organizations that maintain factual databases, such as a weather or demographic database, as further described herein.

The detailed data regarding each visit or interaction between a patient and any healthcare data provider in the healthcare delivery group is typically recorded in significant documentation at step 110. For example, the documentation associated with a typical visit to a healthcare professional may include physical copies of notes from the interaction that detail the patient's verbalized symptoms, as well as any other mental impressions of the healthcare professional. In addition, the documentation may contain diagnostic and laboratory test requests and results; general data submitted to the patient's health plan; evidence or other material indicating the cost or amount associated with the treatment of the patient during the interaction; and copies of any other internal documentation that may become historically relevant to the treatment of the particular individual patient. The diagnostic and laboratory test results and other data obtained during the interaction between the patient and the healthcare professional may be charted and analyzed, if necessary. Finally, the disease states, if any, of the individual patient are diagnosed based on the data obtained from the interaction and coded in an appropriate format and sequence at step 115. It can be appreciated by one skilled in the art that initially any such documentation may be either in electronic or hard copy format, but the documentation should be ultimately electronically formatted, as described herein.

Each of the healthcare care data providers must closely adhere to the strict coding procedure that standardizes medical diagnoses of disease states because the creation of an accurate healthcare profile is dependent upon proper coding of the diagnosed disease state or states of the individual patient. The International Statistical Classification of Diseases and Related Health Problems (ICD) is an example of a detailed coding system of known diseases and injuries. Diagnostic codes are used to group and identify diseases, disorders, symptoms and medical signs for the measurement of morbidity and mortality. Although several ICD diagnostic coding system variations currently exist in practice, the health profile system utilizes the ICD-9 coding system. Individual patient visits may be characterized by four separate ICD-9 codes. Accordingly, every complete diagnosis can be broken into a primary diagnosis, a secondary diagnosis, a tertiary diagnosis and a quaternary diagnosis. It should be noted that any of the other ICD diagnostic coding systems may be utilized in accordance with the features of the disclosed system and method, as described herein. Moreover, other diagnostic coding systems may be used such as the Hierarchical Condition Categories coding system (HCC). The HCC system codes individual patients according to the severity of the disease state to enable health plans to receive cost adjustments based on the degree of illness.

At step 120, the individual patient data obtained from the visit or interaction with the healthcare data provider, in addition to the coded diagnosed disease states, are converted to an electronic format. This can require entering the data into an electronic record utilizing an appropriate database software program. The electronic record may consist of multiple fields of data that are relevant to the individual patient visit and electronically searchable. Any data for an individual patient regarding any interaction with a healthcare data provider should be documented and recorded in a manner similar to the method provided at steps 110, 115 and 120 of FIG. 1. This data may include, but is not limited to, any data relating to visits, interactions, claims, encounters, pharmaceutical preparations, and durable medical equipment. Further, these steps may be performed at any time prior to the inclusion of the data in the creation of a health profile.

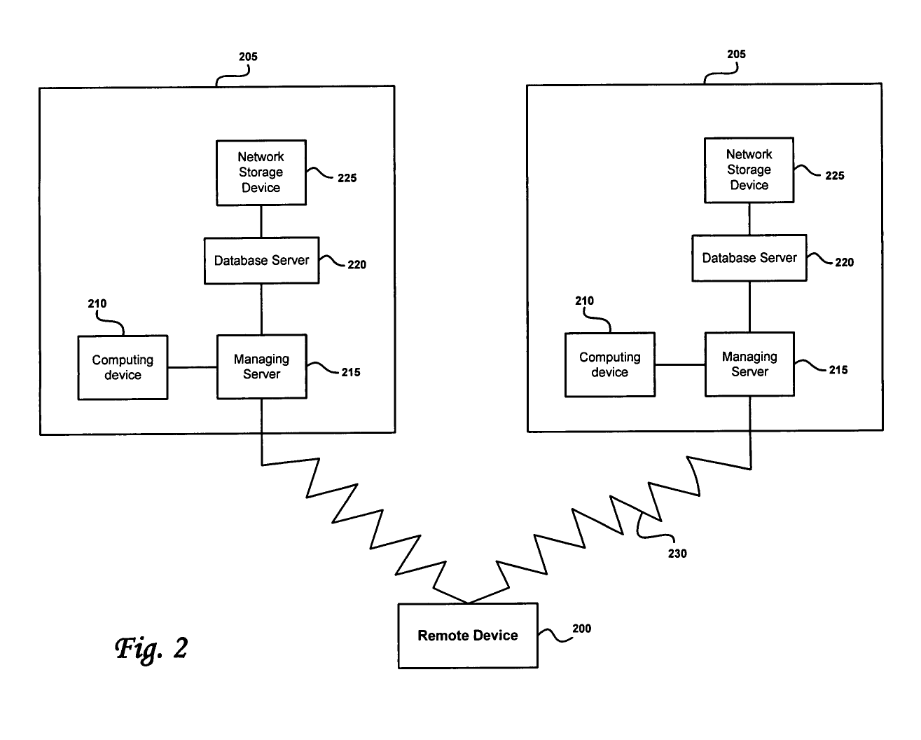

Referring to FIG. 2, a database software program is preferably located on a database server 220 within a healthcare data provider's network 205. Examples of appropriate database software programs include EZ-CAP sold by MZI healthcare, Inc. of Longwood Fla.; Misys sold by Misys Healthcare Systems of Raleigh, N.C.; NextGen sold by NextGen Healthcare Information Systems, Inc. of Horsham, Pa.; MAS90 sold by Sage Software, Inc. of Irvine Calif. or any other similar database software program that may provide for entry and management of patient data such as the software products sold by McKesson Health Solutions of Newton Mass.

The individual patient data is stored in an electronic record format by each healthcare data provider to facilitate the subsequent transfer of healthcare data and creation of the health profile. Accordingly, the network 205 of healthcare data provider preferably includes at least one network storage device 225 which acts as a repository for healthcare data. In particular, network storage device 225 stores data related to the healthcare of each individual patient interaction or visit. It should also be understood that each healthcare data provider represented in FIG. 2 may have multiple network storage devices 225 of various capacities depending on the storage required.

Database server 220 is coupled to network storage device 225 and provides access upon request to the data stored in network storage device 225. Database server 220 is coupled to a managing server 215 which manages the resources of central network 205. Coupled to managing server 215 is at least one computing device 210, such as a desktop personal computer, for entering and managing the data stored in network storage device 225. It should be noted that computing device 210 may be any computing device that can access, transmit and receive data through an electronic network, including, but not limited to, a personal digital assistant.

Network 205 is configured to electronically communicate with a remote device 200 through a global electronic network 225, such as the Internet. In addition, managing server 215 of each healthcare data provider may be in a configuration that is controlled by one or more business entities and further configured to electronically communicate with other healthcare data providers and remote device 200 through a local area network. It should be appreciated by one skilled in the art that the illustrative embodiment shown in FIG. 2 is one suitable computing environment for the present invention and the method described herein may be implemented in any computing environment. For instance, the computing environment of FIG. 2 may be configured on an intranet, thereby limiting a user of the system to practice of the method described herein on a closed system.

Referring again to FIGS. 1 and 2, a user of the disclosed method and system retrieves data at step 125 from at least one healthcare data provider through global electronic network 225 and in connection with remote device 200. Although FIG. 2 represents only two healthcare data providers each having a network 205, it can be appreciated that the health profile may include data from any number of healthcare data providers with each provider having a network 205. In addition to the aforementioned databases, the user may gather data from other databases, including but not limited to the AccuData World Weather Database, maintained by Accuweather of State College, Pa. or any other published demographic database that may provide data relevant to the creation of a health profile for an individual patient or a group of individual patients. Data retrieved from any source other than a healthcare data provider may be imported into the health profile system in any known conventional manner.

The data retrieved at step 125 should contain most of the data gathered from the particular healthcare professional/patient interaction as originally input into an electronic record at step 110. Thus, the retrieved data includes all of the case management data, laboratory and pharmacy data, authorizations and possibly other data contained within each electronic record and related to each of the individual patient's visits, interactions, claims and encounters. The retrieved data contained within each electronic record may include specific data including, but not limited to, member identification, gender, name, the ICD-9 code or codes of the rendered diagnoses, age, place of service, hospitalization dates, provider category, health plan type, prescription medications, cost of provided services, financial or other insurance adjustment codes and other similar data generally recorded in the course of a patient visit or interaction.

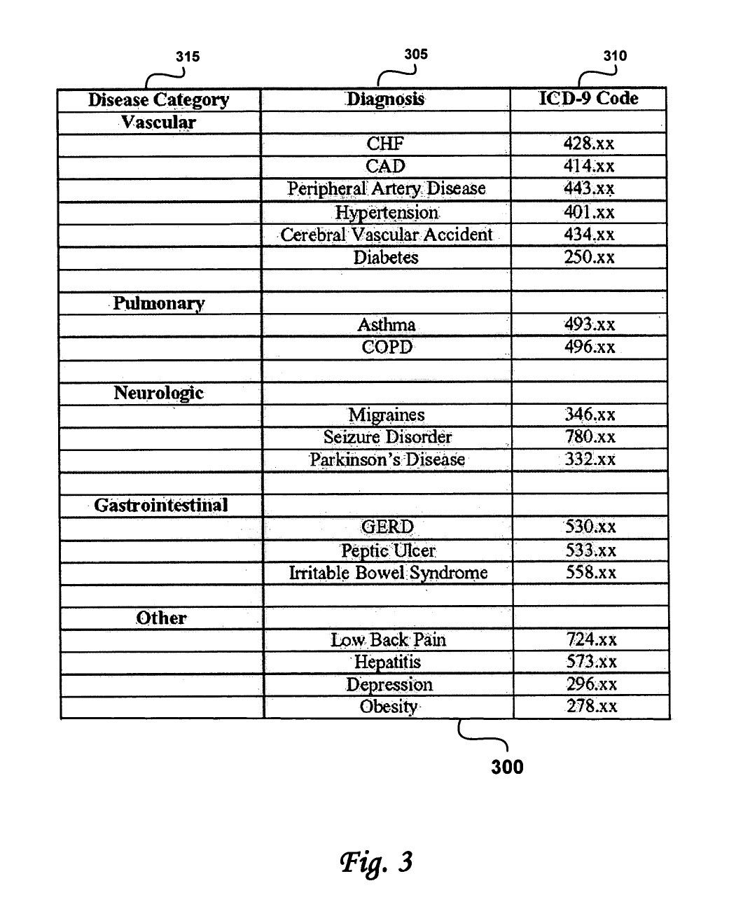

At step 130, the user of the health profile system may select certain data categories from the aforementioned list or any other data category in the retrieved electronic record for inclusion in the health profile. Each electronic record, as retrieved, may contain an unlimited number of data categories that may or may not be relevant to the health profile. One category of data that is relevant to the inquiry and should be included in the health profile is the ICD-9 code. FIG. 3 is an example of a sample disease registry list 300 that includes examples of specific disease diagnoses 305 listed in association with corresponding ICD-9 codes 310 and organized by disease category 315. The ICD-9 codes 310 in FIG. 3 are truncated to a three digit code. However, it should be understood that an ICD-9 code may contain additional digits when initially retrieved in the electronic record of a healthcare data provider. The truncation of ICD-9 codes is further explained within with respect to step 145. After the user selects the categories of data relevant to the inquiry, the user removes any duplicate electronic record data at step 135 so that the set of data ultimately derived from the retrieved data is not skewed with duplicate individual patient treatment data. Duplicate data may consist of any two electronic records that correspond to the same visit, interaction or claim of an individual patient and contain the exact same data.

At step 140, the user derives a subset of data from the existing set of data in which certain categories of data for each visit or interaction are each unique. This derivation is necessary to obtain only one instance of diagnosis of a particular disease state for an individual patient. For example, at step 140 the user may choose to select from the set of data obtained at step 135 the electronic record for each patient visit or interaction having a unique value for each of the following: member identification, gender and primary, secondary, tertiary and quaternary ICD-9 codes.

At step 145, each of the primary, secondary, tertiary and quaternary ICD-9 diagnoses codes are truncated to a three digit code. In the ICD-9 coding system, codes with three digits are included as the heading of a category of codes that may be further subdivided by the use of fourth and/or fifth digits to provide greater detail. For example, certain conditions have both an underlying etiology and multiple body system manifestations due to the underlying etiology. For such conditions, the ICD-9 has a coding convention that requires the underlying condition be sequenced first followed by the manifestation. Only the three digits to the left of the decimal are relevant to the data derivation process of the health profile system. Thus, although diabetes mellitus with neurologic complications corresponds to ICD-9 code 250.6, only the diagnosis of diabetes, and not the underlying etiology, is relevant to the purpose of the health profile system. It should be noted that the user may choose not to truncate the ICD-9 code, in accordance with alternate techniques and preferences for particular data, without departing from the broader aspects of the present invention.

The data obtained at step 145 contains an unlimited number of ICD-9 codes. The number of unique ICD-9 codes may only be limited by the number of ICD-9 codes contained in the data retrieved at step 125. At step 150, the user must select the ICD-9 codes that correspond to the diagnosed disease states of interest from the set of data obtained at step 145. The purpose of the health profile system is to identify certain diagnosed disease states and predict additional expected or unexpected co-morbidities based on the diagnosis. The objective is to proactively manage the individual patient's disease state by developing a comprehensive treatment plan to prevent future episodic events, which also decreases provider utilization and healthcare service costs. Accordingly, the user of the health profile system can determine and select the particular disease states that an individual patient may be likely to suffer from simultaneously and which are relevant to the inquiry.

Referring again to FIG. 3, the user may be concerned with the eighteen identified disease conditions which may further be co-morbidities of each other. For example, obesity is a health problem of increasing concern because it is associated with a variety of unrelated health complications. Further, the development of obesity is influenced by a variety of genetic and environmental factors. Obesity has been specifically shown to correlate with various diseases and systems of the body, which presents a risk factor for increased morbidity and mortality. In particular, obesity has been associated with the development of cardiovascular diseases, endocrine disorders, gastrointestinal disorders, renal and genitourinary disorders, neurologic problems, and respiratory diseases. Each associated disorder tends to further complicate and exacerbate the condition of obesity.

The disease conditions are clustered according to the various systems of the body. Vascular diseases include congestive heart failure, coronary artery disease, peripheral artery disease, hypertension, likelihood of strokes, and diabetes. Pulmonary diseases include asthma and chronic obstructive pulmonary disease. Neurologic complications include migraines, seizure disorder and Parkinson's Disease and gastrointestinal disorders include GERD, peptic ulcer syndrome and irritable bowl syndrome. These identified disease state diagnoses are just a few of the common complications of obesity. Other conditions may include lower back pain, hepatitis and depression.

The data derived in step 150 contains an unlimited number of point of service codes. Each point of service code corresponds to the place of service where the diagnosis was made and treatment was rendered. The point of service may be a hospital, an emergency facility, the individual patient's home, an ambulatory setting, or an inpatient or outpatient facility. Another purpose of the health profile system is to reduce the cost of healthcare services by predicting the co-morbidity and structuring the individual patient's disease management program to prevent the need for additional unnecessary treatment at certain points of service. The cost of healthcare is directly dependent upon the point of service. Thus, at step 155 the user may select the data for one or more particular places of services that correspond to treatment for the diagnosed disease states of interest. The user generates a health profile at step 160.

FIG. 4 is a representation of a health profile 400 created using the disclosed health profile system and method. Health profile 400 contains a map of the healthcare history for an individual patient diagnosed with any combination of the disease states identified in step 150 of FIG. 3. Health profile contains a member identification 405 that contains a numerical or alphanumerical string corresponding to the identification individual patient; plan type 410 which identifies the type of healthcare plan of the individual patient; gender 415 which corresponds to the gender of the individual patient; health plan name 420 which corresponds to the name of the health plan to which the individual patient is a participant; point of service 425 which identifies the category of healthcare provider rendering the treatment or service; and patient age 430 which corresponds to the age of the individual patient. Most importantly, health profile 400 contains disease registry list 435, point of service list 440, and the claim amount paid 445 for the combination of disease states at the points of service identified. Disease registry list 435 identifies all of the combinations of disease states diagnosed in the individual patients as derived from the data retrieved in step 125 of FIG. 1. The patients are further evaluated according to point of service 440 which identifies the types of providers at which the individual patient sought treatment for any of the diagnosed disease states listed in disease registry list 435. Claim paid amount 445 identifies the total cumulative amount paid for each claim associated with the diagnosed disease states identified in disease registry list 435.

FIG. 5 is another representation of a health profile created using the method and system, as described herein. Health profile 400 contains member identification 405, patient gender 415, patient age 430, plan type 410 and disease registry list 435. Health profile 400 further contains hospitalization registry 450 which identifies each hospitalization of the individual patient that corresponds to any single diagnosed disease state or combinations of diagnosed disease states that are identified in disease registry list 435. Hospitalization registry 450 enables a health care provider to better manage the patient's health. For example, hospitalization occurrences should be communicated to the primary care provider that is managing the individual patient's overall health. Frequent hospitalizations may be an indication that the patient is poorly managed.

In the first example at 455, a patient has been hospitalized twice in a time period of one year and nine months for the diagnosed condition of Parkinson's Disease, which is a manageable disease if a patient's primary healthcare provider has the proper oversight of the patient. Although the nature of Parkinson's Disease provides for unexpected health events, such events have only occurred twice in a time period of one year and nine months. The individual patient in the first example at 455 is likely being properly managed. In the second example at 460, the individual patient has been hospitalized four times in less than a one year time period for a variety of conditions that may or may not be related. The frequency of hospitalization for the diagnosed disease states indicates that the patient is not being properly managed. The patient and the primary care provider may not be effectively communicating with respect to behavior modifications or other proper self-care techniques. The primary care provider may not even be aware of the additional provider utilization for the suffered health events. Accordingly, some form of intervention in the patient's health care is necessary. However, the primary health care provider can only intervene if he is aware of the individual patient's health status.

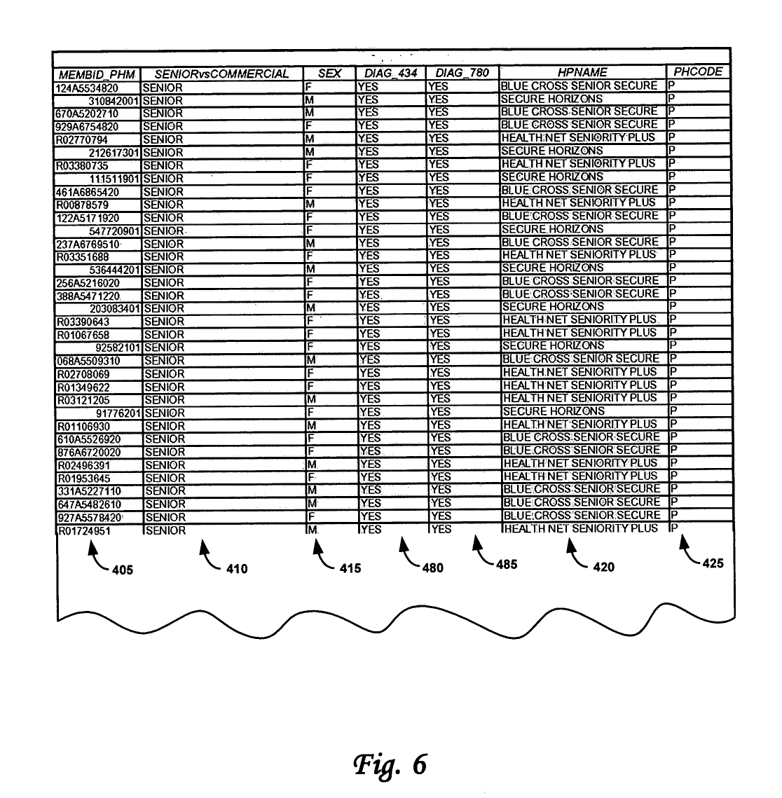

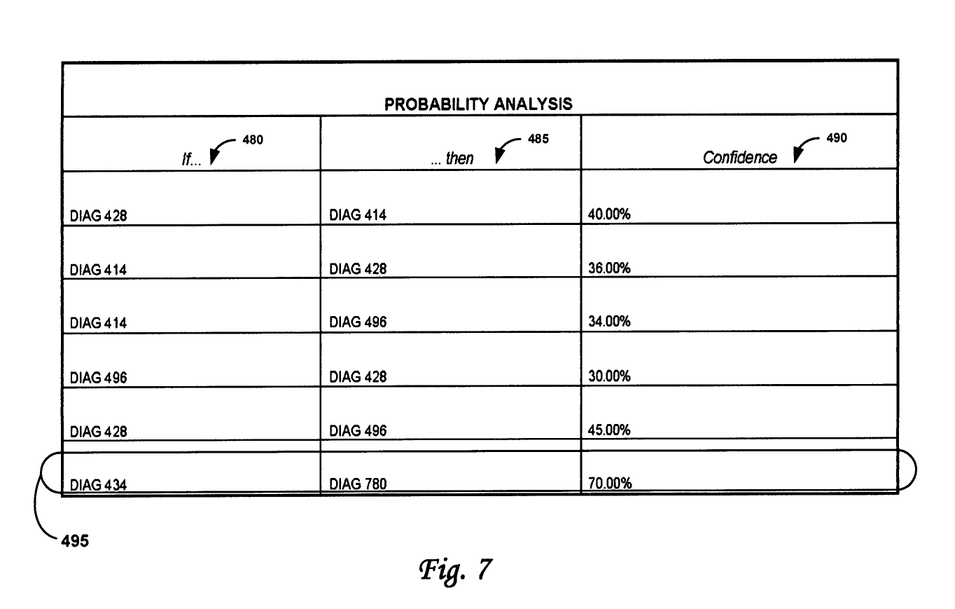

A healthcare provider having access to a health profile may anticipate unexpected co-morbidities with regard to an individual patient through further analysis of the occurrences of co-morbidities in other individual patients. For example, FIGS. 6 and 7 represent another feature of the health profile system in which an analysis can be performed to determine the statistical probability of one disease state occurring simultaneously with at least one additional disease state. FIG. 6 contains a number of identical categories that are found in the health profile of FIG. 4 including member identification 405, plan type 410, patient gender 415, health plan name 420 and point of service 425. At least two diagnosed disease states are selected for this analysis and are identified as a first disease state diagnosis 480 and a second disease state diagnosis 485. Additional disease state diagnoses may be further selected depending on the preference of the health profile system user. FIG. 6 is a first output that identifies each record in the set of data existing at the completion of step 150 of FIG. 1 and whether each individual patient is suffering from either the first disease state diagnosis or the second disease state diagnosis or both simultaneously. The selection of data output of FIG. 6 represents that each individual patient has been diagnosed with the disease states corresponding to ICD-9 codes 434 and 780.

FIG. 7 represents a second output that identifies the likelihood that a patient suffering from one diagnosed disease state may develop another disease state. The health profile system determines the level of confidence 490 based upon the number of occurrences of the selected first and second diagnosed disease state 480, 485 combinations that exist in the data derived at step 150. In the example of 495, if an individual patient is currently diagnosed with first diagnosed disease state 480, then there is a level of confidence 490 of seventy percent that the patient will develop a second diagnosed disease state 485. Specifically, if an individual patient is diagnosed with a first diagnosed disease state 480 of cerebral vascular accident which corresponds to ICD-9 code 434, then there is a 70% probability that the individual patient will be diagnosed with a seizure disorder which corresponds to ICD-9 code 780.

The health profile system calculates the probabilities based on actual individual patient data so the healthcare provider can treat accordingly with a level of certainty. Preventative healthcare strategies and behavior modifications may be implemented before the individual patient develops the co-morbidities. Additionally, the health profile may provide support for other diagnostic procedures that may indicate the initial development of a co-morbidity before the condition is actually diagnosed. Therefore, it can be expected that the usual additional costs incurred may be lower or nonexistent with respect to the added complications and co-morbidities associated with a diagnosed disease state. It should be further noted that the health profile provided to an individual patient's healthcare team does not require the data of the individual patient to be included. For example, any provider or other group within the healthcare delivery system may recognize from the data contained within the health profile of a group of individual patients that one disease state appears to have a likelihood of occurring in association with another disease state and the treatment of a similarly diagnosed individual patient should be managed accordingly.

The health profile may also be analyzed to determine the likelihood of co-morbidities associated with genetic disease states to identify family members that may be at risk for developing any identified disease state. By determining the current health status of the at-risk family members and providing preventative care strategies and behavioral modification programs, the healthcare needs of these family members can be anticipated to reduce the future associated cost of treatment.

A healthcare provider having access to an individual patient's health profile may develop a holistic treatment approach to address each aspect of the patient's general health status because the healthcare provider has a map of the patient's healthcare history. The health profile can be provided to the individual patient's primary physician, in addition to any other healthcare provider that has a role in the healthcare provided to the individual patient. Each provider has a map of the general health state of the individual patient without having to search through volumes of medical data. Moreover, each provider does not have to rely on the often incomplete information provided by the patient with regard to treatment sought from other providers. The health profile may provide a global snapshot of an individual patient's relevant healthcare data, including, but not limited to, past and current diagnosed disease states, hospitalizations, prescription medications, and laboratory tests. The health profile may contain all or any combination of the data contained within the data retrieved at step 125 in FIG. 1. Thus, the health profile should contain the data necessary to guide each health care provider in efficiently managing the treatment of an individual patient.

An individual patient's health profile may be coded on an integrated circuit chip, and implanted or ingested into the patient's body. In the case of implantation, the chip may be implanted anywhere on the body that does not interfere with the operation of the chip. Further, the chip should be able to establish a communication with a device outside the body, such as through wireless or radio transmission, so the data contained on the device may be easily retrieved or updated. This particular application may be implemented for soldiers engaged in military operations or, similarly, other individuals having a medical history that may not be easily accessible. An individual patient's health profile may also be coded on a wearable accessory, including but not limited to, a bracelet, belt, arm band, leg band or necklace.

The individual patient's health profile may also be encoded on a plastic card having a magnetic strip. The card may be provided to a healthcare provider that is providing services to an individual patient. The healthcare provider can swipe the plastic card in a machine adapted to read data encoded in such a manner for further review. The healthcare provider can use the data read from the encoded health profile to manage the general health state of the individual patient, as described herein. The health profile for a group of individual patients may be similarly encoded and provided to any organization or individual that may have an interest in the management of the healthcare treatment and/or associated cost, such as an employer, an insurance company or a healthcare professional. For example, an employer may choose to offer or implement educational or other awareness programs directed to the employees' wellness state. These programs can be directed to an individual or to any group of individuals that share the same or similar health concerns.

The health profile can also be utilized to create a registry of any healthcare data that may be based on two or more disparate databases. For example, the health profile system may be used to create a registry of other types of data including, but not limited to, such data associated with pathology, transplants, end state renal disease, orphan diseases, or hospice care.

To that end, it should be recognized that additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

Through the mechanisms disclosed herein, the systems and methods of the present invention will be operative to identify associations of diagnosed disease states and predict future occurrences of the associated diagnosed disease states. It is contemplated that the systems and methods, although ideally suited for the use within managed care organizations, the same may find widespread applicability in virtually every type of organization responsible for the administration of healthcare, whether public or private in nature, and especially where it is considered desirable to predict future disease states and allocate resources commensurate with such forecasts. Accordingly, all far reaching applications should be considered to fall within the scope of the present invention.

What is claimed is:

1. A method for identifying and mapping a health profile of a group of individual patients comprising
a) identifying a patient population;
b) storing a plurality of individual patient data in a database;
c) retrieving said plurality of said individual patient data;
d) defining at least one category of said individual patient data; and
e) processing said at least one category of said individual patient data to map said patient population according to said at least one category of said individual patient data

2. The method of claim 1, wherein in step a), said patient population comprises the members of a healthcare organization.

3. The method of claim 1, wherein in step a), said patient population comprises any group of individuals for which a set of conditions can be analyzed.

4. The method of claim 1, wherein in step b), said individual patient data comprises a plurality of claims, encounters, authorizations, case management data, laboratory data and pharmacy data.

5. The method of claim 1, where in step c), said plurality of said individual patient data is retrieved from multiple disparate databases.

6. The method of claim 5, wherein said multiple disparate databases includes at least one of a weather database and a published demographic database.

7. The method of claim 1, wherein in step d), said at least one category of data is at least one of cost, point of service, disease state, member identification, hospitalizations, gender and age.

8. The method of claim 1, further comprising the step of encoding the health profile on at least one of an integrated circuit chip and a card having a magnetic strip.

9. The method of claim 8, further comprising the step of reading the encoded health profile from at least one of said integrated circuit chip and said card having a magnetic strip, wherein said health profile is further analyzed to provide guidance in managing the health of an individual patient.

10. The method of claim 1, further comprising the step of retrieving data from at least one of a weather database and a published demographic database.

11. The method of claim 1, further comprising the step of identifying a plurality of providers to provide services to said patient population.

12. The method of claim 11, wherein said plurality of providers comprise physicians, specialists, emergency facilities, inpatient facilities, outpatient facilities, medical groups, insurance companies, employers and government agencies.

13. The method of claim 11, wherein at least one of said plurality of providers makes available a wellness program.

14. The method of claim 7, further comprising the step of identifying an association of disease states.

15. The method of claim 14, further comprising the step of predicting an occurrence of said association of disease states.

16. The method of claim 15, further comprising the step of managing the health of an individual patient based on said occurrence of said association of disease states.

17. The method of claim 14, further comprising the step of implementing at least one of a holistic treatment approach, a preventative care strategy and a wellness program.

18. A system for identifying and mapping a health profile for a group of individual patients, comprising:
a) at least one central network configured to communicate through a global electronic network, said central network further comprising a computing device for inputting a plurality of individual patient data into a database, a database server and a managing server coupled to the database server for providing access to said plurality of individual patient data, and
b) a processor to retrieve said plurality of individual patient data through said global electronic network; to define at least one category of said plurality of individual patient data; to analyze said at least one category of said plurality of individual patient data, and to identify an association in said at least one category of said plurality of individual patient data wherein said association in said at least one category of said plurality of individual patient data is analyzed to provide guidance in managing the health of an individual patient.

19. The system of claim 18, wherein said plurality of individual patient data comprises a plurality of claims, encounters, authorizations, case management data, laboratory data and pharmacy data.

20. The system of claim 18, wherein said plurality of individual patient data is retrieved from multiple disparate databases.

21. The system of claim 20, wherein said multiple disparate databases includes at least one of a weather database and a published demographic database.

22. The system of claim 18, wherein said at least one category of said plurality of individual patient data is at least one of cost, point of service, disease state, member identification, hospitalizations, gender and age.
